(19) United States
(12) Patent Application Publication
(10) Pub. No.: US 2005/0078364 A1
(43) Pub. Date: Apr. 14, 2005

(54) [TELESCOPE]

(76) Inventors: Wen-Tso Tseng, Taoyuan County (TW); Shu-Tung Lu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,955

(22) Filed: Jun. 9, 2004

(30) Foreign Application Priority Data
Oct. 13, 2003 (TW) 92128260

(51) Int. Cl. G02B 23/00; G02B 27/64

(52) U.S. Cl. 359/410; 359/399

(57) ABSTRACT

A type of telescope is described. The telescope comprises a first monocular, a second monocular, an image-recording device and a first optical-switching component. The first monocular comprises a first object lens and a first eyepiece. The second monocular comprises a second object lens and a second eyepiece. The image-recording device is disposed between the first monocular and the second monocular. The first optical-switching component is disposed between the first object lens and the first eyepiece for switching the propagation direction of an incident light from the first object lens to the first eyepiece or the image-recording device. The telescope with the optical-switching component permits the image-recording device to record an image, wherein the field of the recorded image is identical to the field of an image seen by a user.

### CROSS REFERENCE TO RELATED APPLICATIONS

This application claims the priority benefit of Taiwan application serial no. 92128260, filed Oct. 13, 2003.

### BACKGROUND OF INVENTION

1. Field of the Invention

The present invention relates to a telescope. More particularly, the present invention relates to a telescope with an optical-switching component for recording an image, wherein the field of the recorded image is identical to the field of an image seen by a telescope user.

2. Description of Related Art

With the rapid progress in fabricating techniques and the drop in price of most basic devices, integrated multifunctional devices have become the mainstream products in the market. For example, a mobile phone with digital camera function, a home appliance with networking capability, a multifunctional office system capable of photocopying, faxing and printing can be easily affordable. Due to the additional features, many old products have a longer product life before becoming obsolete. Furthermore, as the workweek is gradually reduced so that people can have more leisure time, birds or waterfowls watching are some of the activities favored not only by naturalist or environment lovers but by commoners as well. Besides watching, some of these people would like to record the activities of these beautiful animals branding into the particular landscape too. However, most digital cameras sold in the market have moderate to low magnification capabilities and hence can hardly display far off scenes with clarity. On the other hand, those professional digital cameras having a high magnification capable of capturing scenes at a great distance in sports stadium would sell for a high price that very few people could afford.

Because of the need for a high magnification digital camera, integrating a telescope with a digital camera seems to be the solution. Aside from watching from afar, the user may use the integrated telescope to take a snapshot of the scene so that a permanent record is recorded. This type of telescope with digital camera function is very much welcomed by most environmentalist and nature lovers. Following the recent maturity in the fabrication of digital cameras, the integration of a conventional camera with a telescope has become obsolete. Since all the later versions no longer involve integrating a conventional camera with the telescope, the method of integrating a digital camera with a telescope is illustrated in the following description.

FIG. 1 is a schematic view showing various components inside a conventional binocular type of telescope. As shown in FIG. 1, the telescope mainly comprises a first monocular 100, a second monocular 120 and an image-recording device 140. The first monocular 100 further comprises a first object lens 102, a first eyepiece 104 and a first prism 106 disposed between the first object lens 102 and the eyepiece 104. Similarly, the second monocular 120 further comprises a second object lens 122, a second eyepiece 124 and a second prism 126 disposed between the first object lens 102 and the eyepiece 104. In addition, the image-recording device 140 is disposed between the first monocular 100 and the second monocular 120.

As shown in FIG. 1, the first object lens 102, the first eyepiece 104, the second object lens 122 and the second eyepiece 124 are all fabricated by combining a group of lenses.

In a conventional telescope, the image-recording device 140 further comprises an image-capturing device 142 and an object lens 146. The image-capturing device 142 is positioned on the optical path behind the object lens 146. In addition, the object lens 146 is also fabricated by combining a group of lenses. Furthermore, the image-capturing device 142 is a charge-coupled device (CCD) or a complementary metal-oxide-semiconductor (CMOS) image sensor etc.

Light beams 190 coming from an external source enters the telescope through the first object lens 102 of the first monocular 100 and the second object lens 122 of the second monocular 122. Thereafter, the light beams 190 travel to the first prism 106 and the second prism 126 and then to the first eyepiece 104 and the second eyepiece 124 before emerging from the telescope and impinging on the left and right eye (not shown) of a user. In addition, a light beam 195 coming from the light source also travels to the image-capturing device 142 through the object lens 146 of the image-recording device 140 to facilitate image recording.

It should be noted that the field of the image seen by each monocular in a conventional binocular is slightly different from the field of the image captured by the image-recording device. In other words, the image seen by a user and the image captured by the image-recording device are non-identical. To resolve this problem, the object lens within the image-recording device can be modified. However, to provide an identical field of images for both the monocular and the image-recording device, a larger and a heavier object lens must be used. Ultimately, the binoculars will be bulkier and heavier.

### SUMMARY OF INVENTION

Accordingly, the present invention is directed to a telescope with an optical-switching component for recording an image, wherein the field of the recorded image is identical to the field of an image seen by a telescope user.

According to an embodiment of the present invention, the telescope comprises a first monocular, a second monocular, an image-recording device and a first optical-switching component. The first monocular comprises a first object lens and a first eyepiece. The second monocular comprises a second object lens and a second eyepiece. The image-recording device is disposed between the first monocular and the second monocular. The first optical-switching component is disposed between the first object lens and the first eyepiece for switching the propagation direction of an incident light from the first object lens to the first eyepiece or the image-recording device.

According to an embodiment of the telescope, the first object lens, the first eyepiece, the second object lens and the second eyepiece are fabricated using a group of lenses. In addition, a first prism is also disposed inside the first monocular between the first object lens and the first eyepiece. The second monocular similarly comprises a second prism disposed between the second object lens and the second eyepiece.

According to the aforementioned embodiment of the telescope, the image-recording device further comprises an image-capturing device and a lens assembly. The lens assembly and the image-capturing device are disposed along the optical path behind the first optical-switching component. Furthermore, the lens assembly is disposed between the first optical-switching component and the image-capturing device. The image-capturing device is a charge-coupled device (CCD) or a complementary metal-oxide-semiconductor (CMOS) image sensor, for example. In addition, the image-recording device according to the present embodiment may include a reflector disposed along the optical path between the first optical-switching component and the image-capturing device for changing the propagation direction of the incident light.

According to the aforementioned embodiment of the telescope, the first optical-switching component can be a rotatable reflector capable of switching an incident light beam entering the first object lens to the first eyepiece or the image-recording device. In other words, the first optical-switching component comprises a rotatable mechanism and a reflector with the reflector disposed on the rotatable mechanism.

According to the aforementioned embodiment of the telescope, the first optical-switching component can be an optical element such as a dichroic mirror (DM) or a polarizing beam splitter (PBS). The optical element is capable of diverting a portion of the incident light to the first eyepiece and another portion of the incident light to the image-recording device.

The aforementioned telescope may further include a second optical-switching component. The second optical component is disposed along the optical path between the second object lens and the second eyepiece for switching the incident light from the second object lens to the second eyepiece or the image-recording device. The second optical-switching component can be a rotatable reflector capable of switching the incident light from the second object lens to the second eyepiece or the image-recording device. In other words, the second optical-switching component comprises a rotate mechanism and a reflector with the reflector disposed on the rotate mechanism.

According to the aforementioned embodiment of the telescope, the second optical-switching component can be an optical element such as a dichroic mirror (DM) or a polarizing beam splitter (PBS). The optical element is capable of diverting a portion of the incident light to the second eyepiece and another portion of the incident light to the image-recording device.

The present invention also provides an alternative type of telescope design. The telescope comprises a monocular, an image-recording device and an optical-switching component. The monocular further comprises an object lens and an eyepiece. The image-recording device is connected to the monocular. Furthermore, the optical-switching device is disposed between the object lens and the eyepiece for switching an incident light beam from the object lens to the eyepiece or the image-recording device.

According to another embodiment of the telescope, the object lens and the eyepiece are fabricated using a group of lenses. The monocular further comprises a prism disposed between the object lens and the eyepiece.

According to another embodiment of the telescope, the image-recording device further comprises an image-capturing device and a lens assembly. The lens assembly and the image-capturing device are disposed along the optical path behind the optical-switching component. Furthermore, the lens assembly is disposed between the optical-switching component and the image-capturing device. The image-capturing device is a charge-coupled device (CCD) or a complementary metal-oxide-semiconductor (CMOS) image sensor, for example. In addition, the image-recording device according to the present embodiment may include a reflector disposed along the optical path between the optical-switching component and the image-capturing device for changing the propagation direction of the incident light.

According to another embodiment of the telescope, the optical-switching component can be a rotatable reflector capable of switching an incident light beam entering the first object lens to the eyepiece or the image-recording device. In other words, the optical-switching component comprises a rotatable mechanism and a reflector with the reflector disposed on the rotatable mechanism.

According to another embodiment of the telescope, the optical-switching component can be an optical element such as a dichroic mirror (DM) or a polarizing beam splitter (PBS). The optical element is capable of diverting a portion of the incident light to the eyepiece and another portion of the incident light to the image-recording device.

The optical-switching component in the telescope of the present invention is capable of not only presenting the same field of images to both the eyes of a user and the image-recording device, but also eliminating the need for a dedicated object lens inside the image-recording device. Hence, the telescope can have a lighter weight, smaller volume and inexpensive to fabricate.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view showing various components inside a conventional binocular type of telescope.

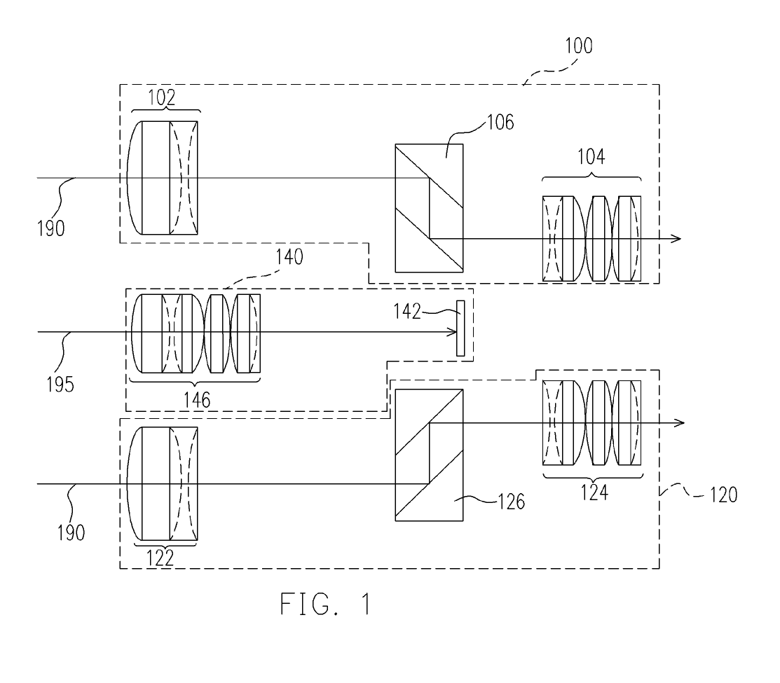

FIG. 2 is a schematic view showing various components inside a telescope according to a first embodiment of the present invention.

FIG. 3A is a schematic view showing various components inside a telescope according to a second embodiment of the present invention.

FIG. 3B is a schematic view showing various components inside a telescope according to a third embodiment of the present invention.

FIG. 4 is a schematic view showing various components inside a telescope according to a fourth embodiment of the present invention.

FIG. 5 is a schematic view showing various components inside a telescope according to a fifth embodiment of the present invention.

FIG. 6 is a schematic view showing various components inside a telescope according to a sixth embodiment of the present invention.

FIG. 7 is a schematic view showing various components inside a telescope according to a seventh embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

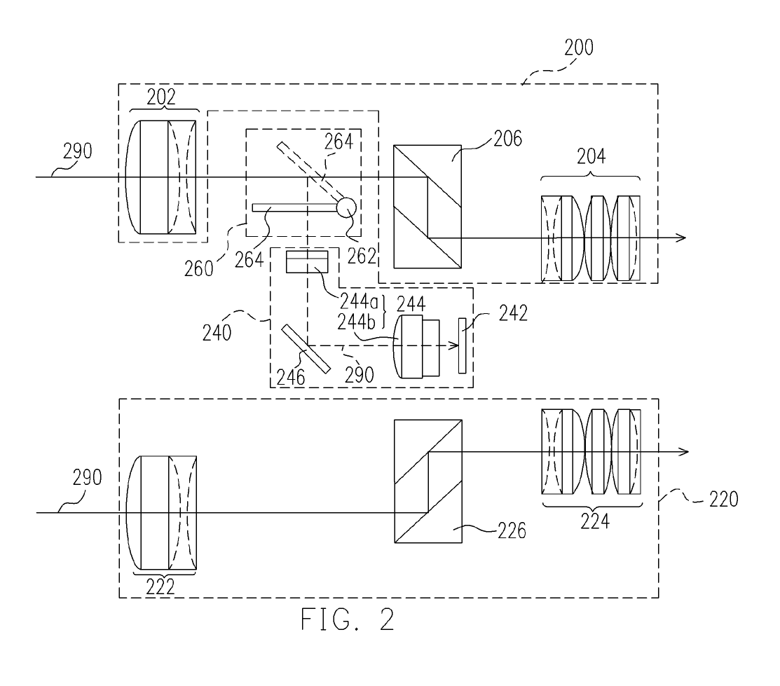

FIG. 2 is a schematic view showing various components inside a telescope according to a first embodiment of the present invention. As shown in FIG. 2, the telescope essentially comprises a first monocular 200, a second monocular 220, an image-recording device 240 and an optical-switching component 260. The first monocular 200 comprises a first object lens 202, a first eyepiece 204 and a first prism 206 disposed between the first object lens 202 and the first eyepiece 204. Similarly, the second monocular 220 comprises a second object lens 222, a second eyepiece 224 and a second prism 226 disposed between the second object lens 222 and the second eyepiece 224. The image-recording device 240 is disposed between the first monocular 200 and the second monocular 220, for example. The first optical-switching component 260 is disposed between the first object lens 202 and the first eyepiece 204, for example, for switching an incident light beam 290 entering the first object lens 202 to the first eyepiece 204 or the image-recording device 240. It should be noted that the first optical-switching component 260 is disposed inside the first monocular 200 or other suitable positions.

According to the first embodiment of the telescope, each of the first object lens 202, the first eyepiece 204, the second object lens 222 and the second eyepiece 244 comprises a lens group, for example. The image-recording device 240 comprises an image-capturing device 242 and a lens assembly 244. The lens assembly 244 comprises two lens groups 244a and 244b, for example. In addition, the lens assembly 244 and the image-capturing device 242 are disposed along the optical path behind the first optical-switching component 260. Furthermore, the lens assembly 244 is positioned between the first optical-switching component 260 and the image-capturing device 242. The image-capturing device 242 is a charge-coupled device (CCD) or a complementary metal-oxide-semiconductor (CMOS) image sensor, for example.

As shown in FIG. 2, the image-recording device 240 further comprises a reflector 246. The reflector 246 is disposed along the optical path between the first optical-switching component 260 and the image-capturing device 242. In the present embodiment, the first optical-switching component 260 is a rotatable reflector comprising a rotatable mechanism 262 and another reflector 264, for example.

In the aforementioned first embodiment of the telescope, an incident light beam 290 from a light source enters the telescope through the first object lens 202 of the first monocular 200 and the second object lens 222 of the second monocular 220. Before activating the first optical-switching component 260, the incident light beam 290 passes through the first object lens 202 of the first monocular 200, the second object lens 222 of the second monocular 220, the first prism 206, the second prism 226, the first eyepiece 204 and the second eyepiece 224 and enters the eyes (not shown) of a user. After activating the first optical-switching component 260, the rotatable mechanism 262 rotates an angle bringing the reflector 264 to a designated location. Therefore, the reflector 264 on the rotatable mechanism 262 will deflect the incident beam 290 from the first object lens 202 of the first monocular 200 towards the image-recording device 240. Thereafter, the deflected beam will pass through the first lens group 244a, the reflector 246 and the second lens group 244b in sequence before focusing on the image-capturing device 242 inside the image-recording device 240.

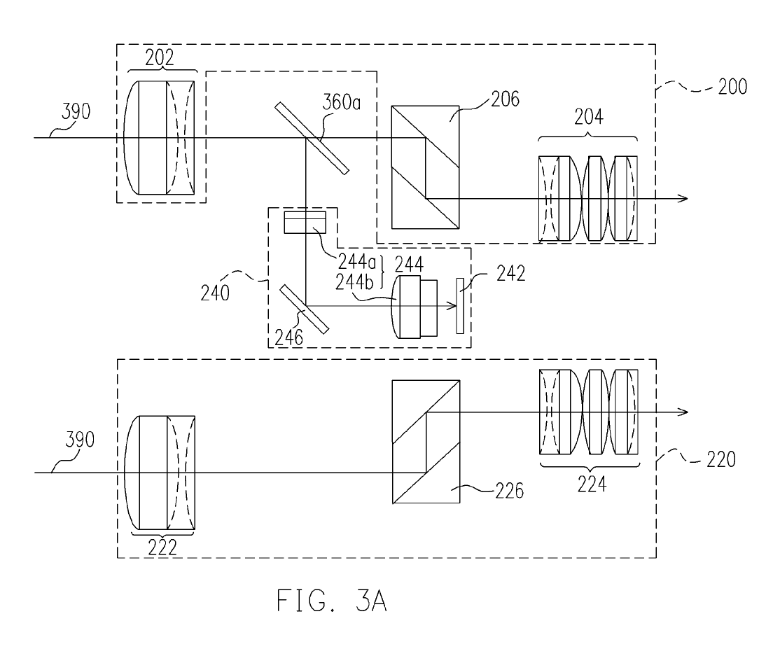

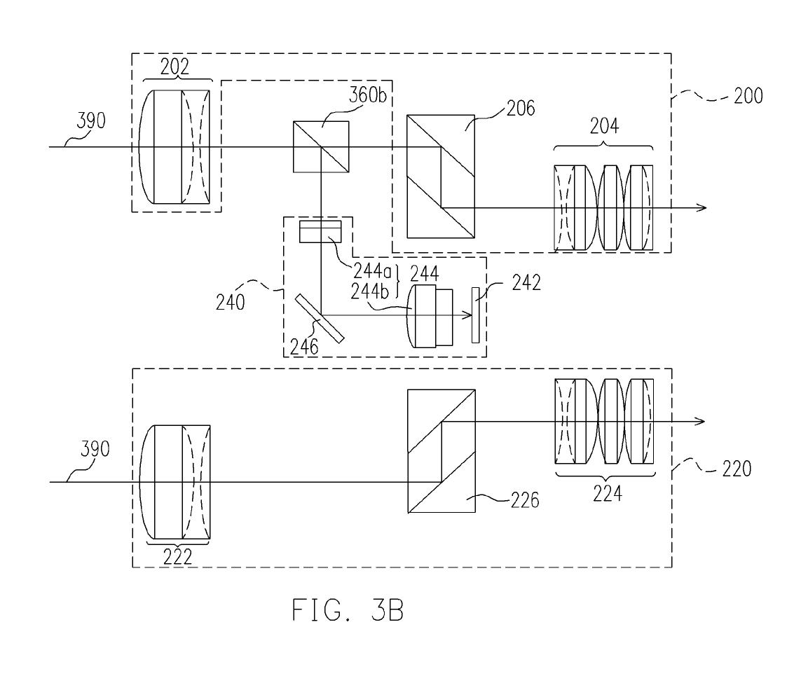

FIG. 3A is a schematic view showing various components inside a telescope according to a second embodiment of the present invention. As shown in FIG. 3A, the second embodiment is similar to the first embodiment. One major difference is that the first optical-switching component 36a is a dichroic mirror (DM). The dichroic mirror is capable of transmitting a portion of the incident light 390 to the first eyepiece 204 and another portion of the incident light 390 to the image-recording device 242. In other words, a portion of the light 390 traveling from the first object lens 202 of the first monocular 200 to the first optical-switching component 360a will be sent to the eyes (not shown) of a user via the first prism 206 and the first eyepiece 204. Meanwhile, another portion of the light 390 will be sent to the image-capturing device 242 of the image-recording device 240 via the lens group 244a of the lens assembly 244, the reflector 246 of the image-recording device 240 and the second lens group 244b of the lens assembly 244.

FIG. 3B is a schematic view showing various components inside a telescope according to a third embodiment of the present invention. As shown in FIG. 3B, the third embodiment is similar to the first embodiment of the present invention. One major different is that the first optical-switching component 360b is a polarizing beam splitter. The polarizing beam splitter is similarly capable of transmitting a portion of the incident light 390 to the first eyepiece 204 and another portion of the incident light to the image-recording device 242. In other words, a portion of the light 390 traveling from the first object lens 202 of the first monocular 200 to the first optical-switching component 360b will be sent to the eyes (not shown) of a user via the first prism 206 and the first eyepiece 204. Meanwhile, another portion of the light 390 will be sent to the image-capturing device 242 of the image-recording device 240 via the lens group 244a of the lens assembly 244, the reflector 246 of the image-recording device 240 and the second lens group 244b of the lens assembly 244.

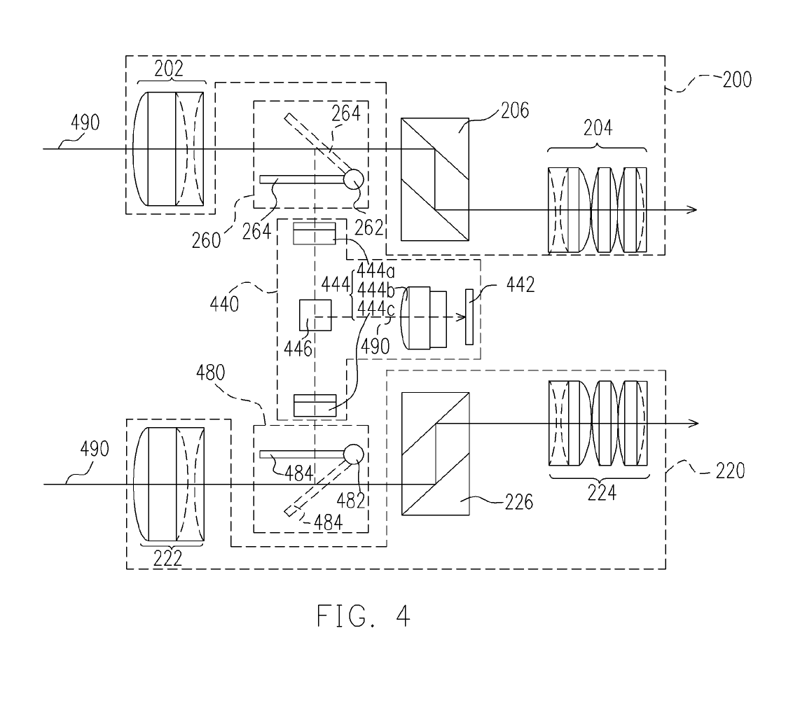

FIG. 4 is a schematic view showing various components inside a telescope according to a fourth embodiment of the present invention. As shown in FIG. 4, the fourth embodiment is similar to the first embodiment of the present invention. One major different is that a second optical-switching component 480 is also installed so that the present embodiment is able to provide the captured image with a perspective. The second optical-switching component 480 is, for example, disposed between the second object lens 222 and the second eyepiece 224 so that an incident light beam 490 falling on the second object lens 222 can be switched to the second eyepiece 224 or the image-recording device 440. Furthermore, the image-recording device 440 comprises an image-capturing device 442 and a lens assembly 444, for example. The lens assembly 444 further comprises a first lens group 444a, a second lens group 444b and a third lens group 444c, for example. It should be noted that the second optical-switching component 480 is disposed inside the second object lens 222 or other suitable location.

As shown in FIG. 4, the image-recording device 440 may further comprise a reflector 446 disposed along the optical path between the second optical-switching component 480 and the image-capturing device 442, for example. In the present embodiment, the second optical-switching component 480 is a rotatable reflector comprising a rotate mechanism 482 and a reflector 484, for example. The reflector 484 is disposed on the rotate mechanism 482.

In the fourth embodiment of the telescope, an incident light beam 490 from a light source enters the telescope through the first object lens 202 of the first monocular 200 and the second object lens 222 of the second monocular 220. Before activating the first optical-switching component 260 and the second optical-switching component 480, the incident light beam 290 passes through the first object lens 202 of the first monocular 200 and the second object lens 222 of the second monocular 220, the first prism 206 and the second prism 226, the first eyepiece 204 and the second eyepiece 224 and enters the eyes (not shown) of a user. After activating the first optical-switching component 260 and the second optical-switching component 480, the rotatable mechanism 262 of the first optical-switching component 260 and the rotatable mechanism 482 of the second optical-switching component 480 rotate an angle in synchrony bringing the reflectors 264 and 482 to designated locations. Therefore, the reflector 264 on the rotatable mechanism 262 will deflect the incident beam 490 from the first object lens 202 of the first monocular 200 towards the image-recording device 440. Besides, the reflector 484 on the rotatable mechanism 482 will deflect the incident beam 490 from the second object lens 222 of the second monocular 220 towards the image recording device 440. Thereafter, the deflected beam from the first optical-switching component 260 will pass through the first lens group 444a, the reflector 446 and the second lens group 444b in sequence before focusing on the image-capturing device 442 inside the image-recording device 440. Similarly, the deflected beam from the second optical-switching component 480 will pass through the third lens group 444c, the reflector 446 and the second lens group 444b in sequence before focusing on the image-capturing device 442 inside the image-recording device 440.

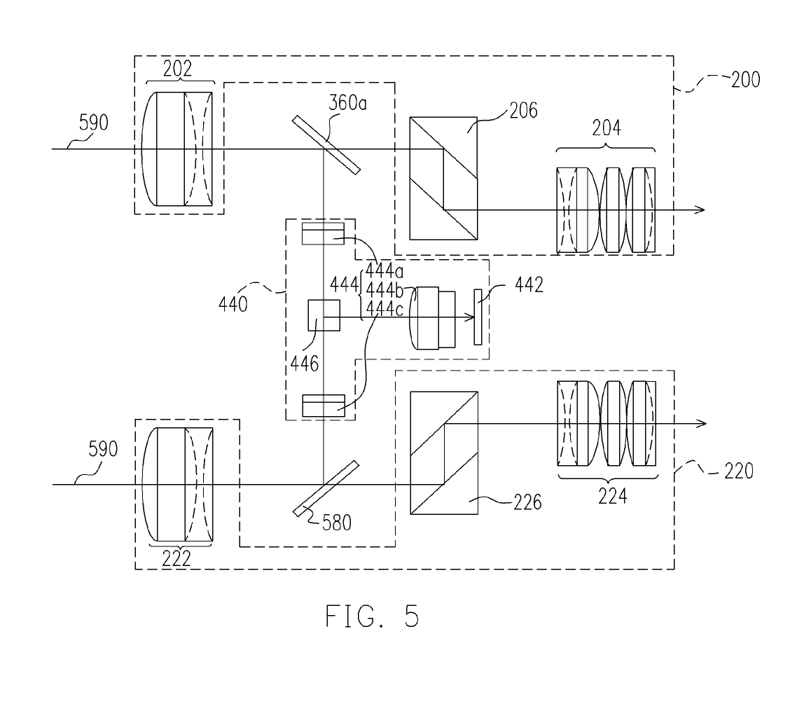

FIG. 5 is a schematic view showing various components inside a telescope according to a fifth embodiment of the present invention. As shown in FIG. 5, the fifth embodiment is similar to the second embodiment of the present invention. One major different is that a second optical-switching component 580 is also installed. The second optical-switching component 580 is a dichroic mirror. The dichroic mirror is capable of transmitting a portion of the incident light 590 to the second eyepiece 224 and another portion of the incident light 590 to the image-recording device 442. In other words, a portion of the light 590 traveling from the second object lens 222 of the second monocular 220 to the second optical-switching component 580 will be sent to the eyes (not shown) of a user via the second prism 226 and the second eyepiece 224. Meanwhile, another portion of the light 590 will be sent to the image-capturing device 442 of the image-recording device 440 via the third lens group 444c of the lens assembly 444, the reflector 446 and the second lens group 444b of the lens assembly 444.

In the aforementioned fifth embodiment, the second optical-switching component is not limited to a dichroic mirror. A polarizing beam splitter may also be used to achieve a similar effect.

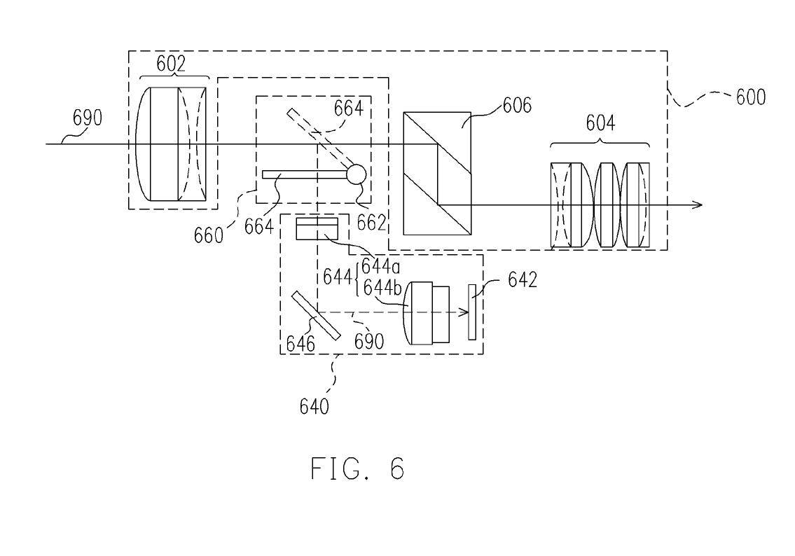

FIG. 6 is a schematic view showing various components inside a telescope according to a sixth embodiment of the present invention. As shown in FIG. 6, the telescope comprises a monocular 600, an image-recording device 640 and an optical-switching component 660. The monocular 600 further comprises an object lens 602, an eyepiece 604 and a prism 606 disposed between the object lens 602 and the eyepiece 604. The image-recording device 640 is disposed on the monocular 600. The optical-switching component 660 is disposed between the object lens 602 and the eyepiece 604 for switching an incident light beam 690 from the object lens 602 to the eyepiece 604 or the image-recording device 640. It should be noted that the optical-switching component 660 is disposed inside the object lens 602 or other suitable location. In addition, the object lens 602 and the eyepiece 604 comprise lens groups, for example.

According to the sixth embodiment of the telescope, the image-recording device 640 comprises an image-capturing device 642 and a lens assembly 644, for example. The lens assembly 644 further comprises a first lens group 644a and a second lens group 644b, for example. The image-capturing device 642 is disposed along the optical path behind the optical-switching component 660. Furthermore, the lens assembly 644 is positioned between the optical-switching component 660 and the image-capturing device 642. The image-capturing device 642 is a charge-coupled device (CCD) or a complementary metal-oxide-semiconductor (CMOS) image sensor, for example. It should be noted that the image-recording device 640 may further include a reflector 646 disposed along the optical path between the optical-switching component 660 and the image-capturing device 642. In the present embodiment, the optical-switching component 660 is a rotatable reflector comprising a rotatable mechanism 662 and another reflector 664, for example.

In the aforementioned sixth embodiment of the telescope, an incident light beam 690 from a light source enters the telescope through the object lens 602 of the monocular 600. Before activating the optical-switching component 660, the incident light beam 690 passes through the object lens 602, the prism 606, the eyepiece 604 of the monocular 600 and enters the eye (not shown) of a user. After activating the optical-switching component 660, the rotatable mechanism 662 rotates an angle bringing the reflector 664 to a designated location. Therefore, the reflector 664 on the rotatable mechanism 662 will deflect the incident beam 690 from the object lens 602 of the monocular 600 towards the image-recording device 640. Thereafter, the deflected beam will pass through the first lens group 644a, the reflector 646 and the second lens group 644b in sequence before focusing on the image-capturing device 642 inside the image-recording device 640.

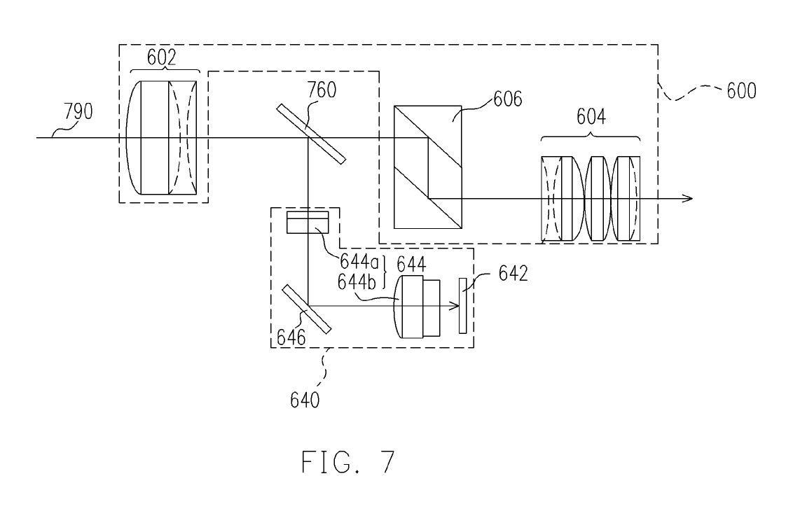

FIG. 7 is a schematic view showing various components inside a telescope according to a seventh embodiment of the present invention. As shown in FIG. 7, the seventh embodiment is similar to the sixth embodiment of the present invention. One major different is that the optical-switching component 760 is a dichroic mirror. The dichroic mirror is capable of transmitting a portion of the incident light 790 to the eyepiece 604 and another portion of the incident light 790 to the image-recording device 642. In other words, a portion of the light 790 traveling from the object lens 602 of the monocular 600 to the optical-switching component 760 will be sent to the eye (not shown) of a user via the second prism 606 and the eyepiece 604. Meanwhile, another portion of the light 790 will be sent to the image-capturing device 642 of the image-recording device 640 via the lens group 644a of the lens assembly 644, the reflector 646 and the lens group 644b of the lens assembly 644.

In the aforementioned seventh embodiment, the optical-switching component is not limited to a dichroic mirror. A polarizing beam splitter may also be used to achieve a similar effect.

In summary, major advantages of the telescope according to the present includes:
1. The telescope has an optical-switching component for providing the human eye and the image-recording device with an identical field of images.
2. There is no need to include an object lens dedicated to the image-recording device so that the telescope is lighter, occupies less volume and has a lower production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A telescope for observing and/or recording an image, comprising:
a first monocular, having a first object lens and a first eyepiece;
a second monocular, having a second object lens and a second eyepiece;
an image-recording device, disposed between the first monocular and the second monocular; and
a first optical-switching component, disposed between the first object lens and the first eyepiece for deflecting an incident light beam from the first object lens to the first eyepiece or the image-recording device.

2. The telescope of claim 1, wherein the first object lens comprises a lens group.

3. The telescope of claim 1, wherein the first eyepiece comprises a lens group.

4. The telescope of claim 1, wherein the second object lens comprises a lens group.

5. The telescope of claim 1, wherein the second eyepiece comprises a lens group.

6. The telescope of claim 1, wherein the first monocular further comprises a first prism disposed between the first object lens and the first eyepiece.

7. The telescope of claim 1, wherein the second monocular further comprises a second prism disposed between the second object lens and the second eyepiece.

8. The telescope of claim 1, wherein the image-recording device further comprises:
an image-capturing device; and
a lens assembly, wherein the lens assembly and the image-capturing device are disposed along the optical path behind the first optical-switching component and the lens assembly is disposed between the first optical-switching component and the image-capturing device.

9. The telescope of claim 8, wherein the image-capturing device comprises a charge-coupled device or a complementary metal-oxide-semiconductor image sensor.

10. The telescope of claim 8, wherein the image-recording device further comprises a reflector disposed along the optical path between the first optical-switching component and the image-capturing device.

11. The telescope of claim 1, wherein the first optical-switching component comprises a rotatable reflector.

12. The telescope of claim 1, wherein the first optical-switching component comprises:
a rotate mechanism; and
a reflector disposed on the rotate mechanism.

13. The telescope of claim 1, wherein the first optical-switching component comprises a dichroic mirror or a polarizing beam splitter.

14. The telescope of claim 1, wherein the telescope further comprises a second optical-switching component disposed between the second object lens and the second eyepiece for deflecting an incident light beam from the second object lens to the second eyepiece or the image-recording device.

15. The telescope of claim 14, wherein the second optical-switching component comprises a rotatable reflector.

16. The telescope of claim 14, wherein the second optical-switching component further comprises:
a rotate mechanism; and
a reflector disposed on the rotate mechanism.

17. The telescope of claim 14, wherein the second optical-switching component comprises a dichroic mirror or a polarizing beam splitter.

18. A telescope for observing and/or recording an image, comprising:
a monocular, having an object lens and an eyepiece;
an image-recording device, connected to the monocular; and
an optical-switching component, disposed between the object lens and the eyepiece for deflecting an incident light beam from the object lens to the eyepiece or the image-recording device.

19. The telescope of claim 18, wherein the object lens comprises a lens group.

20. The telescope of claim 18, wherein the eyepiece comprises a lens group.

21. The telescope of claim 18, wherein the monocular further comprises a prism disposed between the object lens and the eyepiece.

22. The telescope of claim 18, wherein the image-recording device further comprises:
an image-capturing device; and
a lens assembly, wherein the lens assembly and the image-capturing device are disposed along the optical path behind the optical-switching component and the lens assembly is disposed between the optical-switching component and the image-capturing device.

23. The telescope of claim 22, wherein the image-capturing device comprises a charge-coupled device or a complementary metal-oxide-semiconductor image sensor.

24. The telescope of claim 22, wherein the image-recording device further comprises a reflector disposed along the optical path between the optical-switching component and the image-capturing device.

25. The telescope of claim 18, wherein the optical-switching component further comprises a rotatable reflector.

26. The telescope of claim 18, wherein the optical-switching component further comprises:
a rotate mechanism; and
a reflector disposed on the rotate mechanism.

27. The telescope of claim 18, wherein the optical-switching component further comprises a dichroic mirror or a polarizing beam splitter.
